(19) United States
(12) Patent Application Publication
(10) Pub. No.: US 2010/0102580 A1
(43) Pub. Date: Apr. 29, 2010

(54) ENERGY ABSORBER WITH DIFFERENTIATING ANGLED WALLS

(76) Inventors: Ryan J. Brooks, Allen Park, MI (US); Patrick Fenchak, Rochester, MI (US); Daniel D. Ralston, Farmington Hills, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/581,524

(22) Filed: Oct. 19, 2009

Related U.S. Application Data
(60) Provisional application No. 61/107,717, filed on Oct. 23, 2008.

(51) Int. Cl. B60R 19/34

(52) U.S. Cl. 293/133

(57) ABSTRACT

A vehicle includes a beam and fascia over the beam, and an energy absorber mounted between the beam and fascia. The energy absorber is thermoplastic and has energy-absorbing wall geometries that are forwardly facing and configured to absorb energy from a low speed impact against a pedestrian. The wall geometries having multiple wall sections defining multiple draft angles and lengths adapted to buckle at transitions of the multiple draft angles during the low speed impact, with the numbers and types of draft angles and transitions of these draft angles being varied to provide a selected amount of resistance force needed to absorb an optimal amount of energy over time during the impact. The energy absorber is tuned for optimal minimized injury to an impacted object.

This is a utility application under 35 U.S.C. §119(e) claiming benefit of provisional application Ser. No. 61/107,717, filed Oct. 23, 2008, entitled ENERGY ABSORBER WITH DIFFERENTIATING ANGLED WALLS.

### BACKGROUND

The present invention relates to vehicle bumper and energy-absorbing systems, and more particularly to an energy absorber component tunable for optimal energy absorption, such as for a pedestrian impact on a secondary bumper beam and/or for primary impact on a primary bumper beam.

Modern vehicles have bumper systems tuned for particular energy absorption during a vehicle impact. However, tuning of bumper systems is not easy due to the many conflicting design requirements, such as limitations on the “package space” taken up by the bumper system, limitations on bumper beam flexure and rear intrusion into the space behind the beam, and limitations on cost, quality, dimensional consistency and consistency/predictability of the impact energy-absorbing profile during the impact stroke. Recently, there has been increasing concern and regulation over pedestrian impacts in an effort to reduce pedestrian injury during such an impact, which has added yet another “layer” of difficulty and complexity to bumper system design and tuning of bumper systems. Concurrently, a problem is that present energy absorbers do not have as much design flexibility as desired.

### SUMMARY OF THE PRESENT INVENTION

In one aspect of the present invention, a bumper system for a vehicle having a vehicle frame includes a beam configured for attachment to the vehicle frame and a fascia covering at least a portion of a front surface of the beam. The bumper system further includes an energy absorber positioned between the beam and the fascia. The energy absorber has walls forming at least one tubular energy-absorbing geometry that protrudes in a first direction away from the front surface of the beam and that are configured to absorb energy from an impact against an object or a pedestrian. The wall geometries are formed by multiple side wall sections that each define different draft angles to the first direction and that include lengths adapted to buckle at transitions of the multiple draft angles during the impact. The numbers and types of the draft angles and the transitions of these draft angles are varied to provide a selected amount of initial increasing resistance force and then continuous resistance force to absorb a desired amount of energy over time during the impact, the energy absorber being tuned for optimal minimized injury to an impacted object or pedestrian for the vehicle.

In a narrower form, the energy absorber is made from a thermoform process.

In another narrower form, the draft angles define at least two different angle values, and the lengths of wall sections define at least two different length distances.

In a still narrower form, at least some of the draft angles are between about 25-35 degrees.

In another aspect of the present invention, an energy absorber article is provided for use on a vehicle having a beam and fascia over the beam, where the energy absorber article is mounted to one of the beam and fascia and positioned therebetween. The energy absorber article comprises an energy absorber made from thermoplastic material and having walls forming energy-absorbing geometries that are forwardly facing and configured to absorb energy from a low speed impact against an object or a pedestrian; the walls having multiple wall sections defining multiple draft angles and lengths in the geometries and being adapted to buckle at transitions of the multiple draft angles during the low speed impact, with the numbers and types of draft angles and transitions of these draft angles being varied to provide a selected amount of resistance force needed to absorb an optimal amount of energy over time during the impact, the energy absorber being tuned for optimal minimized injury to an impacted object or pedestrian.

These and other aspects, objects, and features of the present invention will be understood and appreciated by those skilled in the art upon studying the following specification, claims, and appended drawings.

### BRIEF DESCRIPTION OF DRAWINGS

FIG. 1 is an exploded perspective view of a vehicle bumper system with beams, energy absorbers, and fascia.

FIGS. 2A-2C are cross-sectional side views of different energy-absorbing geometries in the energy-absorbing geometries of FIG. 1.

FIG. 3 is an enlarged cross-sectional side view of a particular energy-absorbing geometry.

FIG. 4 is a fragmentary perspective view showing a particular energy-absorbing construction and shape.

FIGS. 5-6 are perspective and end views of a crush box including undulations on top and bottom walls for stabilizing the top and bottom walls during an impact.

FIG. 7 is a graph comparing energy absorption during a crush stroke against energy absorbers with similar crush boxes, but with one energy absorber including undulations on top and bottom walls and one energy absorber not including undulations.

### DETAILED DESCRIPTION OF PREFERRED EMBODIMENTS

The present bumper system includes a beam and an energy absorber mounted on the beam and covered by fascia. The illustrated energy absorber includes energy-absorbing protrusions that face forwardly as mounted to a vehicle to absorb energy from a low speed impact or a pedestrian impact against a front of a vehicle. The illustrated energy absorber is made from a thermoplastic material by a thermoform process, but can also potentially be made from an extrusion or injection molding process. However, it is contemplated that the energy absorber could also be made from another energy-absorbing material, such as metal. The energy absorber has a cross-sectional geometry with side walls having multiple different draft angles. This design allows for the buckling of the energy absorber at the transitions of the different draft angles. The degree value, sectional length, number of draft angles and type of transition of these draft angles can vary depending on the amount of resistance force needed over each stage of the impact stroke. Thus, the present energy absorber design is flexible enough to be readily tunable to a particular vehicle application, such as for optimal force absorption to minimize pedestrian injury.

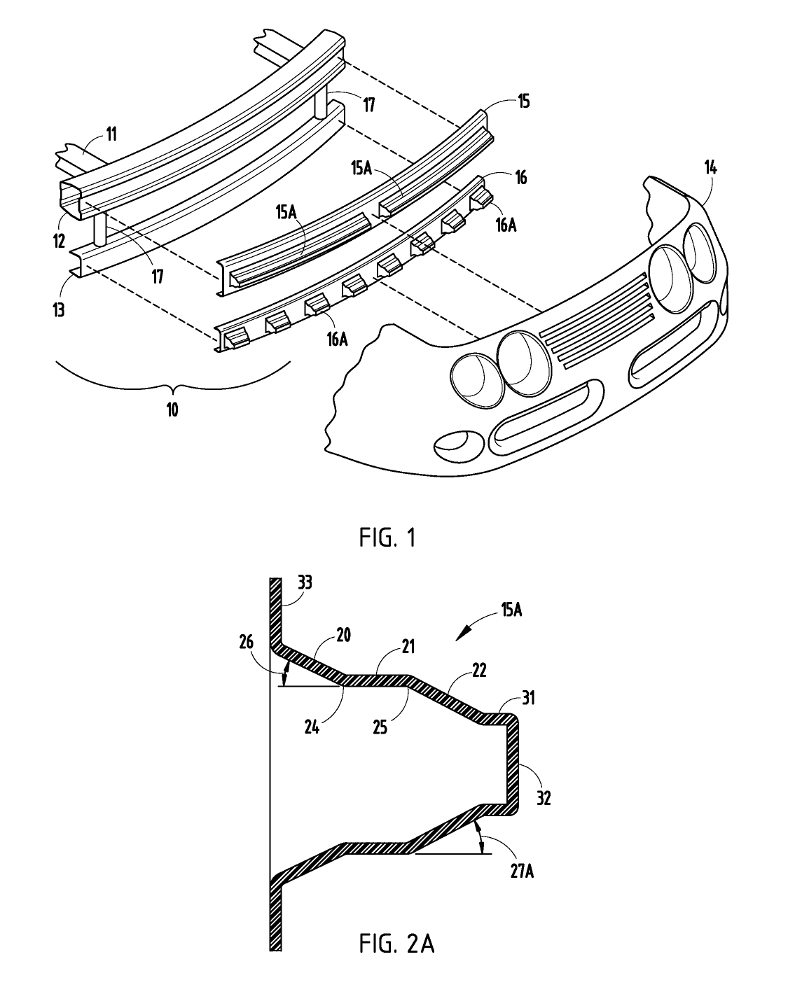

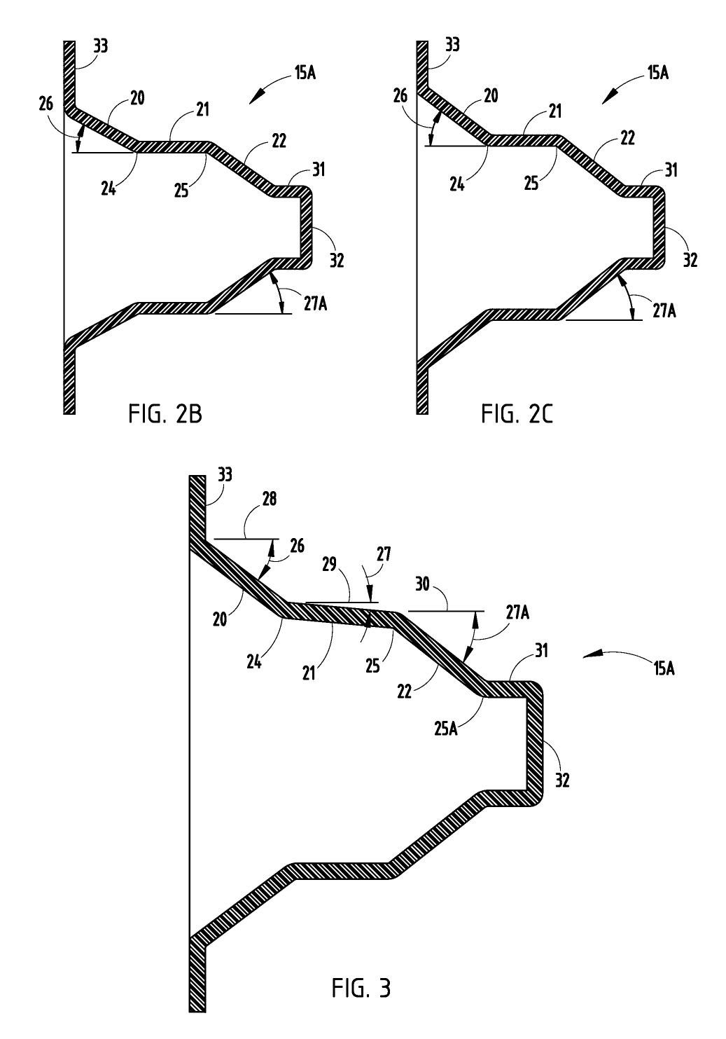

More specifically, the apparatus 10 (FIGS. 1-2) includes a vehicle frame 11 having one or more bumper reinforcement beams, such as a top beam 12 (e.g., higher strength for vehicle-to-vehicle impact at higher impact energies), a “catcher” bottom beam 13 (e.g., for lower energy impacts such as for pedestrian impacts), and a fascia 14 covering (or substantially covering) the beams 12-13. As illustrated, an energy absorber 15 is mounted to the top beam 12 under the fascia 14, and a second energy absorber 16 is mounted to the bottom beam 13 under the fascia 14.

The illustrated top beam 12 is a roll-formed longintudinally-swept tubular beam, such as are known in the art. However, it is contemplated that the top beam 12 can have a variety of different cross-sectional and longitudinal shapes and still be within the present inventive concept. Similarly, the illustrated bottom beam 13 is a roll-formed longitudinally-swept (or linear) non-tubular beam, such as are known in the art. It is also contemplated that the bottom beam 13 can have a variety of different cross-sectional and longitudinal shapes and still be within the present inventive concept. The presently illustrated bottom beam 13 is supported by brackets 17 extending down from the top beam 12 and/or extending down from other structure on the vehicle frame.

Both illustrated energy absorbers 15 and 16 are made from an engineering grade thermoplastic material for optimal energy absorption upon crushing collapse during an impact. They each have walls forming protruding tubular energy-absorbing geometries 15A and 16A (also called “crush boxes” or “energy-absorbing protrusions”). The illustrated geometries are generally square or rectangularly shaped, hollow, and forwardly facing (relative to a vehicle front when mounted in front of a vehicle) and configured to absorb energy from an impact against an object or a pedestrian. However, it is contemplated that the geometries can face toward the beam (such as if the energy absorber is attached to a fascia). The illustrated energy absorber 15 has two such geometries 15A (i.e., each being horizontally-elongated box-shaped shapes and extending cross-car from a center of the energy absorber toward an end of the energy absorber). The other energy absorber 16 has a plurality of pyramid-shaped energy-absorbing geometries 16A (i.e., “crush boxes”) (eight such geometries being illustrated). It is contemplated that a scope of the present invention includes forming a single energy-absorbing geometry extending completely across the beam (see energy absorber 15 in FIG. 1, but modified to eliminate the center gap between the two illustrated energy-absorbing geometries), as well as forming two or more energy-absorbing geometries across a length of the energy absorber in single or multiple rows.

The illustrated wall geometries in FIGS. 2A-2C and 3 are formed from a base flange 33, and each include multiple wall sections (three angled wall sections 20, 21, 22 being illustrated in FIG. 3 along with outer side wall section 31 and perpendicular end wall section 32. It is contemplated that a scope of the present invention includes more or less angled wall sections. The illustrated wall sections 20-22 and 31 define three joints 24 and 25 and 25A (i.e. lines of intersection), each being illustrated as a corner in FIG. 3. The wall sections 20-21 define multiple draft angles 26 and 27 and 27A with the outer side wall section 31 and also have different heights 28-30 (which based on their different heights and angles thus represent different actual lengths). For example, in FIG. 2A, walls 20, 21, 22 are at angles 30 degrees, 3 degrees, and 30 degrees, while in FIG. 2B the angle of wall 22 is greater than 30 degrees, and in FIG. 2C the angle of wall 20 is greater than 30 degrees. A preferred range of angles for some walls is about 25-35 degrees and for others it is about 1-10 degrees. Also, it is contemplated that the joints 24 and 25 and 25A can define different radii and shapes at the joint. Thus the walls at joints 24-25A are adapted to buckle at the transitions that they define during the low speed impact, with the numbers and types of draft angles and transitions of these draft angles affecting the force of increasing resistance to the impact during each stage of an impact stroke. For example, the initial impact can be made to provide a slightly lower initial impact strength (such as at the very first impact of a pedestrian) and a second stage can provide an increased initial impact strength (such as at a second stage of more severe impact against a pedestrian). (See FIG. 7.) By varying the wall section lengths, angles, and transition shapes, the energy absorbers 14-15 can be tuned to provide a selected amount of resistance force needed to absorb an optimal amount of energy over time during the impact. Thus, the energy absorber(s) can be tuned for optimal minimized injury to an impacted pedestrian and for optimal minimized damage to a vehicle, and for optimal minimized damage to a vehicle itself.

The illustrated energy absorber 15 is made by injection molding (where plastic material is melted to a molten state and flowed into a cavity where it is cooled), and the energy absorber 16 is made by a thermoform process (i.e. where a sheet of plastic material is heated and then formed over a die as it cools). However, it is also contemplated that an energy absorber can be made by extrusion, compression molding, and other techniques while still being within a scope of the present invention. The illustrated energy-absorbing structure includes at least two different angle values, and the lengths of its wall sections define at least three different length distances and three different draft angles. The illustrated draft angles of the larger angled wall sections (such as wall sections 20 and 23) are between about 25-35 degrees, while the illustrated draft angles of the smaller angled wall section (wall section 22) are between about 2-10 degrees, while the wall section 31 is at a minimal draft angle such as 1-2 degrees.

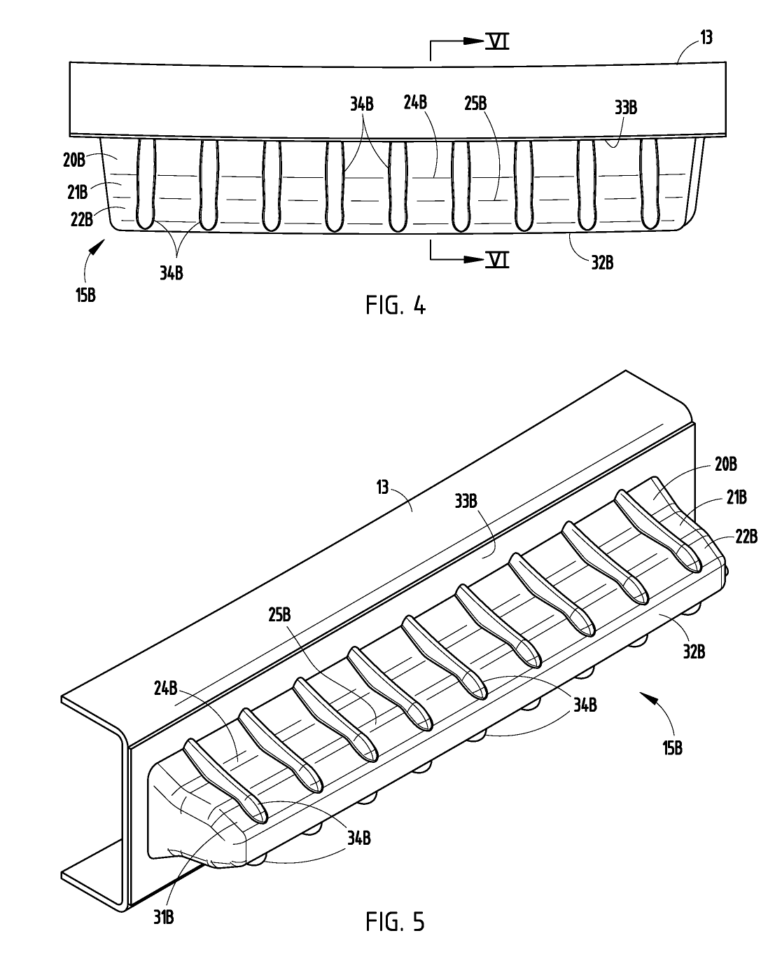

The illustrated energy absorber 15 has two energy-absorbing geometries 15A, each extending along about half of a longitudinal length of the energy absorber. The illustrated energy absorber 16 has a plurality of pyramid-shaped projections 16A extending in a forward direction, with the projections 16A being about symmetrical and four-sided. It is contemplated that the energy-absorbing geometries 15A and 16A can have side wall sections with different geometric shapes, such as flat planar side wall portions (see the energy absorbers of FIGS. 1-3), or arcuate side wall sections (similar to FIG. 3 but modified to define arcuate shapes as seen in FIG. 3), or they can have ribs (see FIGS. 4-6), or can have a mixed set of same.

FIG. 4 illustrates a single cell energy-absorbing geometry 15B, where the side walls include planar sections at various angles. The geometry 15B uses the same numbers as given for geometry 15 and 15A in FIGS. 2-3, but uses the additional letter “B.” The wall geometries each include multiple wall sections (wall sections 20B, 21B, 22B, 31B but of course there could be more or less), with their joints defining multiple draft angles and different heights. Further, geometry 15B includes gussets or ribs 34B extending between wall sections 20B, 21B and 22B and across the joints 25B and 24B, which provide a different energy absorption profile during the impact stroke (i.e., a different collapse sequence and structure and energy absorption across the joint 25B upon impact).

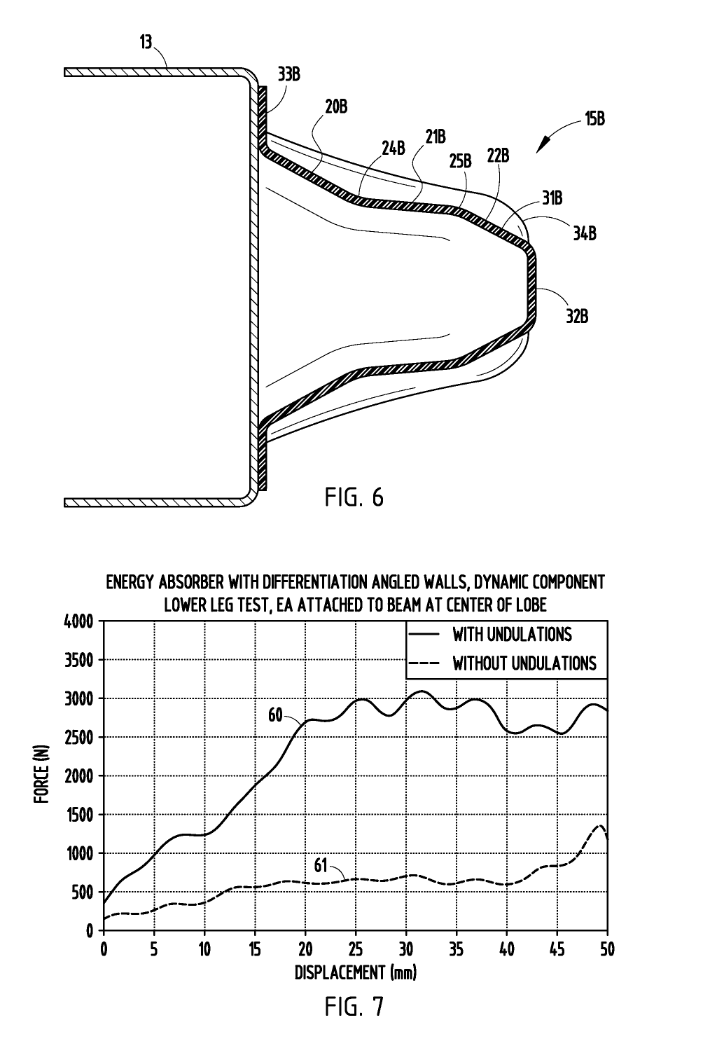

Notably, a number, shape, size, length and location of the ribs (34B) can be varied as needed to provide an energy absorption profile best-suited for a particular application. FIGS. 5-6 show a particular shape of ribs 34B on a crush box in an energy absorber 15C similar to the crush box of energy absorber 15B (FIG. 4). All corners between and around the illustrated walls 20B-22B, 31B-32B and ribs 34B are radiused to facilitate thermo-forming or molding, with the illustrated ribs 34B being basically formed as undulations in the top and bottom side walls of the energy-absorbing crush boxes. These undulations stabilize the walls during an impact, thus making the energy absorption greater. Specifically, a first energy absorber with a first shape and weight and having undulations or ribs in its undulating side walls will outperform a second energy absorber having a same shape and weight but NOT having undulations in its side walls. See FIG. 7, which shows a graph of force versus deflection of two comparable energy absorbers, one having undulated side walls and the other not having undulated side walls. Also, this property allows an energy absorber having undulations in its wall sections to be reduced in material and weight (i.e., to have thinner wall thicknesses) while still absorbing a same amount of energy during an impact as a similarly shaped energy absorber without undulated walls (but with thicker walls).

Specifically, FIG. 7 is a graph showing force of resistance during an impact stroke (y scale being force in N, x axis being displacement in mm), line 60 being for an energy absorber with undulations in its top and bottom side walls, line 61 being for a similarly-shaped energy absorber without undulations in its side walls. Specifically, two similarly-shaped energy absorbers were tested, one energy absorber being like that shown in FIGS. 5-6, being similar but without undulations. An initial force of resistance for the first energy absorber with undulated side walls was about 400 N, while the initial force of resistance for the second energy absorber without undulated walls (i.e., with planar walls) was about 200N. Further, after a displacement (impact stroke) of 5 mm, the force of resistance of the first energy absorber with undulated side walls was about 1000N, which was greater than triple the second energy absorber with planar walls, which was about 250N. At a displacement of 20 mm, the force of resistance of the first energy absorber with undulated side walls increased to about 2700 N, while the second energy absorber with planar side walls only reached about 700 N.

Thus, by varying the numbers and types of draft angles and transitions of these draft angles, and also by varying a length and shape of the walls and the undulations therein, an initial force of resistance (and concurrent energy absorption) can be designed into the energy absorber during a crushing impact, as well as a preferred rate of increase of force of resistance (and concurrent energy absorption), as well as a preferred maximum continuous force of resistance (and concurrent energy absorption) during the crushing impact. This allows flexibility in designing the energy absorber, since it can be quickly and relatively easily tuned for optimal minimized injury to an impacted object or pedestrian.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A bumper system for a vehicle having a vehicle frame, comprising:
a beam configured for attachment to the vehicle frame and a fascia covering at least a portion of a front surface of the beam; and
an energy absorber positioned between the beam and the fascia, the energy absorber having walls forming at least one tubular energy-absorbing geometry that protrudes parallel a perpendicular direction from the front surface of the beam and that are configured to absorb energy from an impact against an object or a pedestrian; the wall geometries being formed by multiple side wall sections that each define different draft angles to the first direction and lengths adapted to buckle at transitions of the multiple draft angles during the impact, with the numbers and types of the draft angles and the transitions of these draft angles being varied to provide a selected amount of initial increasing resistance force and then continuous resistance force to absorb a desired amount of energy over time during the impact, the energy absorber being tuned for optimal minimized injury to an impacted object or pedestrian for the vehicle.

2. The bumper system defined in claim 1, wherein the energy absorber is made from a sheet of constant thickness by a thermoform process.

3. The bumper system defined in claim 1, wherein the draft angles define at least two different angle values.

4. The bumper system defined in claim 3, wherein the lengths of wall sections define at least two different length distances.

5. The bumper system defined in claim 1, wherein the lengths of wall sections define at least two different length distances.

6. The bumper system defined in claim 1, wherein at least one of the draft angles is between about 25-35 degrees.

7. The bumper system defined in claim 6, wherein a second one of the draft angles is between about 1-10 degrees.

8. The bumper system defined in claim 7, wherein a third one of the draft angles is different and is also between about 25-35 degrees.

9. The bumper system defined in claim 1, wherein the wall sections define 3 different draft angles.

10. The bumper system defined in claim 1, wherein the at least one energy-absorbing geometry includes a plurality of energy-absorbing geometries along a longitudinal length of the energy absorber.

11. The bumper system defined in claim 10, wherein the plurality includes at least four energy-absorbing geometries.

12. The bumper system defined in claim 1, wherein the energy-absorbing geometries each define a flat-topped pyramid-shaped projection.

13. The bumper system defined in claim 12, wherein the pyramid-shaped projections have side walls formed by flat side wall sections.

14. The bumper system defined in claim 1, including a second beam below the first-mentioned beam also mounted to the frame, and including a second energy absorber on a face of the second beam and under the fascia.

15. The bumper system defined in claim 13, where the second energy absorber includes at least one tubular energy-absorbing geometry that protrudes away from a front surface of the second beam.

16. The bumper system defined in claim 1, wherein the geometries extend away from the face.

17. An energy absorber article for use on a vehicle having a beam and fascia over the beam, where the energy absorber article is mounted to one of the beam and fascia and positioned therebetween, the energy absorber article comprising:
an energy absorber having walls forming energy-absorbing geometries that are forwardly facing and configured to absorb energy from an impact against an object or a pedestrian; the walls having multiple wall sections defining multiple draft angles and lengths in the geometries and being adapted to buckle at transitions of the multiple draft angles during the impact, with the numbers and types of draft angles and transitions of these draft angles being varied to provide a selected amount of resistance force needed to absorb an optimal amount of energy over time during the impact, the energy absorber being tuned for optimal minimized injury to an impacted object or pedestrian.

18. The energy absorber defined in claim 17, wherein the energy absorber is made from a sheet by a thermoform process.

19. The energy absorber defined in claim 17, wherein the draft angles define at least two different angle values.

20. The energy absorber defined in claim 17, wherein the lengths of wall sections define at least two different length distances.

21. The energy absorber defined in claim 17, wherein at least one of the draft angles is between about 25-35 degrees.

22. The energy absorber defined in claim 17, wherein the wall sections define 3 different draft angles, and where a top of the geometries is flat.
